(19) United States
(12) Patent Application Publication
(10) Pub. No.: US 2010/0089306 A1
(43) Pub. Date: Apr. 15, 2010

(54) PORTABLE FUEL GAUGE FOR FUEL TANK

(75) Inventors: Gary L. Dunkle, Connersville, IN (US); Louis T. Frank, Connersville, IN (US)

Correspondence Address: BARNES & THORNBURG LLP, 11 SOUTH MERIDIAN, INDIANAPOLIS, IN, 46204, US

(73) Assignee: STANT MANUFACTURING INC., Connersville, IN (US)

(21) Appl. No.: 12/554,808

(22) Filed: Sep. 4, 2009

Related U.S. Application Data
(60) Provisional application No. 61/094,346, filed on Sep. 4, 2008.

(51) Int. Cl. G01F 23/30

(52) U.S. Cl. 116/228; 73/309

(57) ABSTRACT

A fuel gauge is adapted to extend into a fuel tank to enclose liquid fuel in the fuel tank and to sense the level of liquid fuel in the fuel tank. The fuel gauge includes a fuel-level indicator having a needle and a buoyant float exposed to the liquid fuel in the fuel tank. The needle moves in response to changes in the level of liquid fuel in the fuel tank sensed by the buoyant float.

This application claims priority under 35 U.S.C. §119(e) to U.S. Provisional Application Ser. No. 61/094,346, filed Sep. 4, 2008, which is expressly incorporated by reference herein.

### BACKGROUND

The present disclosure relates to a fuel gauge, and particularly to a portable fuel gauge. More particularly, the present disclosure relates to a portable fuel gauge using mechanical means for determining the amount of liquid fuel in a fuel tank.

### SUMMARY

A fuel gauge in accordance with the present disclosure is adapted to extend into a fuel tank to reach and sense an amount of liquid fuel in the fuel tank. The fuel gauge includes a fuel cap adapted to mate with a fuel-tank filler neck included in the fuel tank, a needle configured to visually indicate the amount of liquid fuel in the fuel tank, and a buoyant float arranged to sense the level of liquid fuel in the fuel tank. The needle moves in response to changes in the level of liquid fuel the fuel tank sensed by the buoyant float.

In illustrative embodiments, the fuel gauge further includes needle-mover means for converting up-and-down movement of the buoyant float in the fuel tank into pivoting movement of the needle about the pivot axis. The needle is positioned to lie in a sealed display space on an exterior surface of the fuel cap so that the movement of the needle visually communicates the liquid fuel level in the fuel tank while fuel vapor is retained in the fuel tank.

In illustrative embodiments, the needle-mover means includes a twistable-guide rod coupled to an interior surface of the fuel cap to rotate about an axis of rotation and a magnetic arm coupled to the twistable-guide rod to move therewith. The magnetic arm is configured to provide magnetic means for moving the needle in response to rotation of the magnetic arm by the twistable-guide rod. In illustrative embodiments, the buoyant float is coupled to twistable-guide rod to cause the twistable-guide rod to rotate about the axis of rotation as the buoyant float moves up-and-down with the liquid fuel level in the fuel tank.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of an illustrative portable fuel gauge for a gas tank made in accordance with the present disclosure showing the fuel tank gauge oriented along a pivot axis and positioned for installation on a fuel tank filler neck as suggested in FIG. 2;

FIG. 2 is a diagrammatic view of the fuel gauge of FIG. 1 coupled to a fuel tank filler neck showing that the illustrative fuel gauge includes a cap including a handle adapted to mate with the fuel tank filler neck, a fuel-level indicator coupled to an external upper surface of the cap, an indicator positioner coupled to an interior lower surface of the cap and configured to communicate the vertical height of liquid fuel in the fuel tank to the fuel-level indicator using magnetic means for coupling indicator positioner and the fuel-level indicator;

FIG. 3 is an exploded perspective assembly view of the fuel gauge illustrated in FIG. 1 showing the fuel gauge includes a cap comprising a handle configured to mate with fuel tank filler neck and a seal plate coupled to the handle, a fuel-level indicator including a needle mounted to the seal plate and configured for pivotable movement, a fuel-level display coupled to the seal plate, and a display lens coupled to the seal plate to enclose the needle and the fuel-level display, and an indicator positioner comprising a base-support rod interconnecting a receiver base and the seal plate, a twist-guide rod positioned to lie in spaced-apart relation and generally parallel to the base-support rod, a level float configured to move along the base-support rod in response to the level of fuel in the fuel tank, and a magnetic arm coupled the upper end of twist-guide rod and configured to rotate about an axis of rotation with the twistable-guide rod;

FIG. 4 is an a perspective view similar to FIG. 1 showing an illustrative fuel gauge may include an engine-supply connection included in the seal plate and positioned below the fuel-level indicator, the engine-supply connection opens into a fuel-conducting passageway formed within the base-support rod permitting fuel to be drawn up through the fuel-conducting passageway from the fuel tank and moved to an engine;

FIG. 5 is a perspective view similar to FIG. 1 showing a fuel-transport orifice formed in the receiver base and opening into the fuel-conducting passageway and showing the level float coupled to the base-support rod and twist-guide rod suggesting the level float can move up and down along the base-support rod without obstruction in response to the level of fuel in the fuel tank thereby positioning the twist-guide rod causing the magnetic arm to cooperate with the needle to indicate the level of fuel in the fuel tank on the fuel-level indicator; and

FIG. 6 is a sectional view taken along line 5-5 of FIG. 1 showing the fuel-level indicator is separated from the indicator positioner by the seal plate and showing that the level float orients the rotational position of twist-guide rod to cause the position of the magnetic arm to vary according the vertical height of fuel in the fuel tank thereby causing the isolated needle to move in direct relation to movement of the magnetic arm.

### DETAILED DESCRIPTION

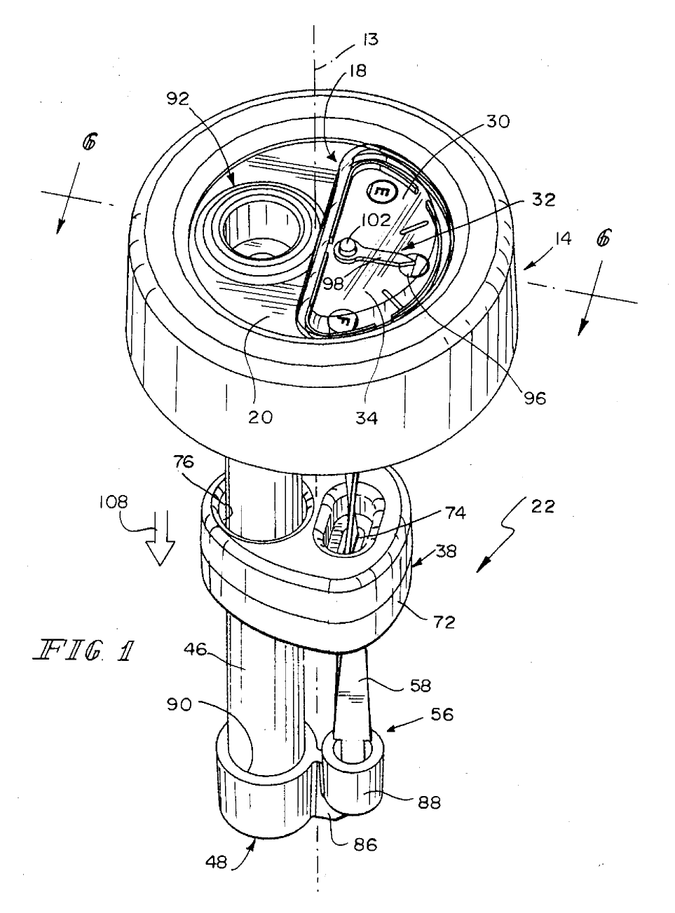

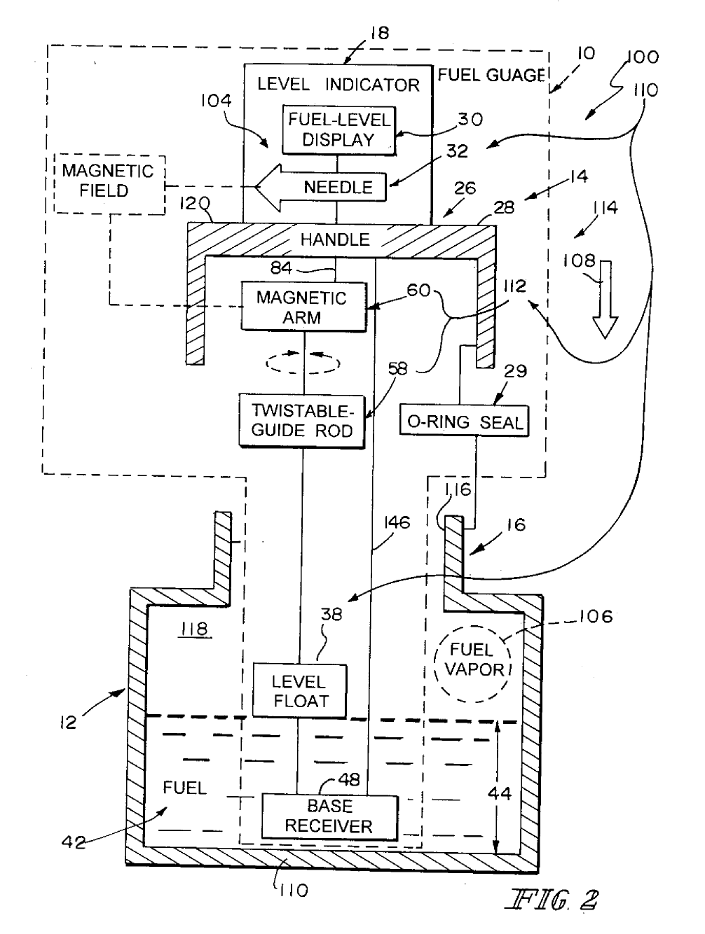

An illustrative portable fuel gauge 10 is shown in FIG. 1 and is adapted for use with a fuel tank 12 (not shown) to indicate the relative amount of fuel contained within fuel tank 12. Fuel gauge 10 is illustratively installed on a filler neck 16 of fuel tank 12 so that fuel gauge 10 is positioned to lie along a generally vertical pivot axis 13. Illustratively, fuel gauge 10 includes a fuel cap 14 configured to mate with a fuel-tank filler neck 16, a fuel-level indicator 18 coupled to an outer surface 20 of fuel cap 14, and a indicator positioner 22 coupled to an inner surface 24 of fuel cap 14 and configured to extend through fuel-tank filler neck 16 into fuel tank 12 as suggested in FIG. 2.

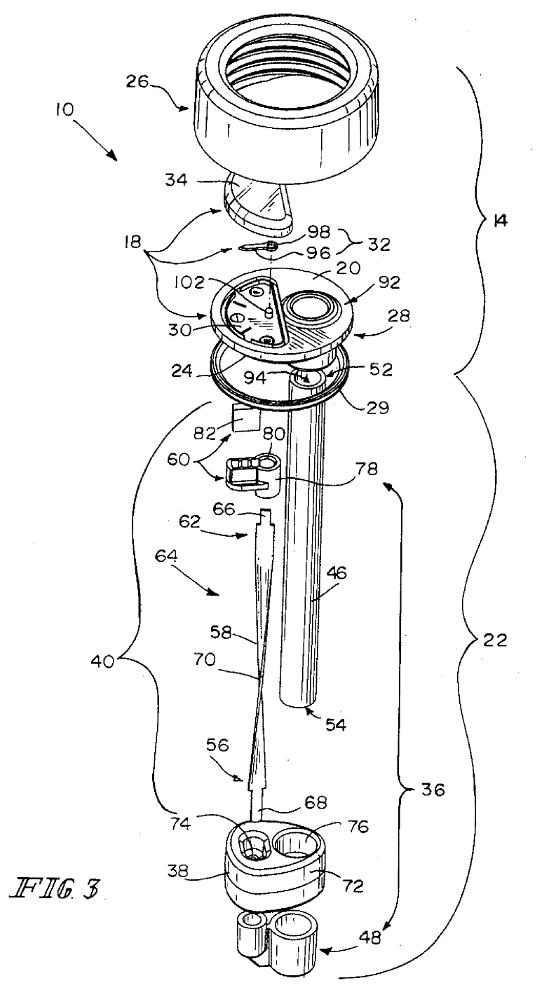

As illustrated in FIG. 3, fuel cap 14 includes a handle 26 configured to cooperate with a user's hand (not shown), a seal plate 28, and an O-ring seal 29. Handle 26 is adapted to mate with filler neck 16 to allow fuel gauge 10 to be removed from filler neck 16. Seal plate 28 is coupled to handle 26 and includes the outer and inner surfaces 20, 24 of fuel cap 14. O-ring seal 29 is positioned to lie between handle 26 and filler neck 16 to seal the connection.

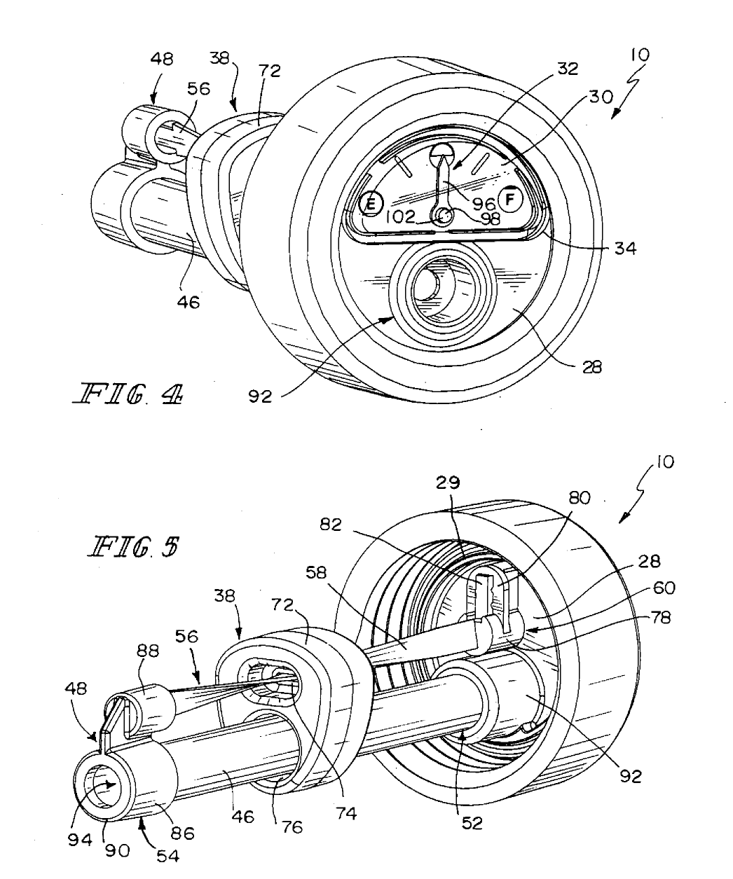

Fuel-level indicator 18 includes a fuel-level display 30, a needle 32, and a display lens 34 as shown in FIGS. 1, 3, and 4. Fuel-level display 30 is coupled to outer surface 20 of seal plate 28. Needle 32 is coupled to seal plate 28 and configured to pivot over a span of about 180 degrees. Display lens 34 is coupled to and cooperates with seal plate 28 to substantially enclose needle 32 and fuel-level display 30.

Indicator positioner 22 illustratively includes a base 36, a level float 38, and a float-rotation assembly 40. Float-rotation assembly 40 is couple on one end to seal plate 28 and on the other end to base 36. Level float 38 is configured to float on the surface of liquid fuel 42 as suggested in FIG. 2. Level float 38 is further configured to cooperate with base 36 and float-rotation assembly 40 to communicate a vertical height 44 of liquid fuel 42 in fuel tank 12 to fuel-level indicator 18.

Base 36, as shown in FIG. 3, illustratively includes a base-support rod 46 and a base receiver 48. Base-support rod 46 includes a first end 52 and a second end 54 and is coupled to seal plate 28 at first end 52. Base receiver 48 is positioned to lie in spaced-apart relation to seal plate 28 and is coupled to second end 54 of base-support rod 46. Base receiver 48 is further configured to receive a lower portion 56 of float-rotation assembly 40.

Float-rotation assembly 40, as shown in FIG. 3, includes a twistable-guide rod 58 and a magnetic arm 60. Twistable-guide rod 58 is coupled to base receiver 48 at lower portion 56 and coupled magnetic arm 60 at an upper end 62. Magnetic arm 60 is configured for pivoting movement over a span of about 180 degrees and is coupled to seal plate 28.

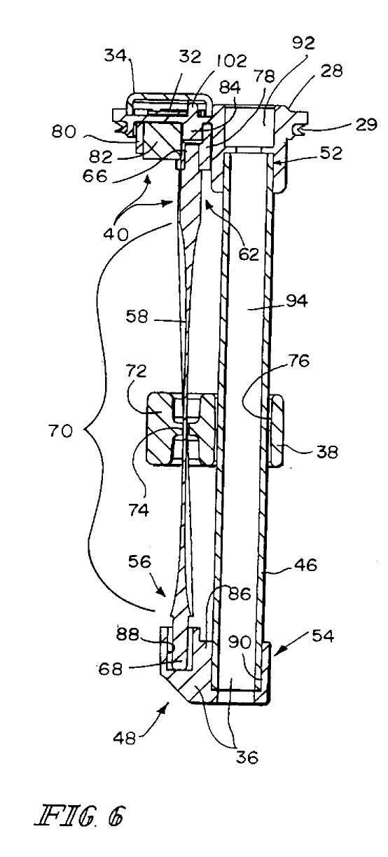

As illustrated in FIGS. 3 and 6, twistable-guide rod 58 illustratively is a thin metal strip 64 formed to include a top pivot tab 66, a bottom pivot tab 68, and a central portion 70. Top pivot tab 66 is formed to mate with base receiver 48 to allow free rotation of twistable-guide rod 58. Similarly, top pivot tab 66 is coupled to magnetic arm 60 so that magnetic arm 60 must rotate in response to movement of twistable-guide rod 58.

Central portion 70 is established by rotating upper end 62 relative to lower portion 56 until thin metal strip 64 has deformed and top pivot tab has rotated about 180 degrees relative to bottom pivot tab 68. Level float 38 moves up and down along base-support rod 46 in response to vertical height 44 of liquid fuel 42 causing twist-guide rod to move.

As illustrated in FIGS. 1, 3, and 5, level float 38 includes a float body 72, a guide-rod channel 74 formed in float body 72, and a support-rod slot 76 formed in float body 72. Guide-rod channel 74 extends through float body 72 and is configured so that the dimensions of guide-rod channel 74 are just slightly larger than twistable-guide rod 58. Furthermore, guide-rod channel 74 is configured so that twistable-guide rod 58 cannot rotate relative to level float 38. And as level float 38 moves along base-support rod 46 twistable-guide rod 58 slides through guide-rod channel 74. Similarly, support-rod slot 76 extends through float body 72 and is configured so that the dimensions of base-support rod 46 are slightly smaller than support-rod slot 76.

Magnetic arm 60, as illustrated in FIG. 3, includes a pivot support 78, a magnet receiver 80, and a magnet 82. Pivot support 78 is coupled to top pivot tab 66 of twistable-guide rod 58 to move therewith and configured to pivot about a float-rotation pivot nub 84 coupled to and included in seal plate 28. Magnet receiver 79 is coupled to pivot support 78 to move therewith and to magnet 82 is mounted magnet receiver 80 to also move therewith.

Needle 32, as illustrated in FIGS. 1, 3, and 4 includes a needle body 96 and a needle-pivot aperture 98 opening through needle body 96. Needle-pivot aperture 98 is adapted to mate with a needle-pivot nub 102 coupled to outer surface 20 of seal plate 28. Needle-pivot aperture 98 and needle-pivot nub 102 cooperate to allow needle 32 to move in response to movement of magnetic arm 60 thereby indicating the amount of liquid fuel 42 in fuel tank 12. Illustratively, needle 32 is made of metal that that responds the magnetic field established by magnet 82.

Base receiver 48, as shown in FIGS. 5 and 6, includes base-receiver body 86, a twist-guide support 88 appended to base-receiver body 86, and a support-rod channel 90 formed in base-receiver body 86. Twist-guide support 88 cooperates with bottom pivot tab 68 of twistable-guide rod 58 to permit free rotation of twistable-guide rod 58. Support-rod channel 90 is formed in base-receiver body 86 so that base-support rod 46 can extend through base-receiver body 86.

Illustratively, fuel gauge 10 as shown in FIGS. 1 and 3-6, also includes an engine-supply connection 92 coupled to seal plate 28. Engine-supply connection 92 allows a fuel-supply line to be connected to fuel gauge 10 to withdraw liquid fuel 42 from fuel tank 12. Engine-supply connection 92 opens into a fuel-conducting passageway 94 formed in base-support rod 46. Fuel-conducting passageway 94 extends through base-support rod 46 and opens into fuel tank 12 permitting fuel to be moved from fuel tank 12 through fuel-conducting passageway 94 and engine-supply connection 92 and to the fuel-supply line. Engine-supply connection 92 is of the quick-connect type, but may be any type of connection that minimizes loss of fuel vapor during connection and disconnection.

Movement of needle 32 relative to fuel-level display 30 is accomplished by magnetic arm 60 moving needle 32 by use of the magnetic field of magnet 82. Furthermore, seal plate 28 does not have any holes formed within it associated with the movement of needle 32. The lack of apertures formed in seal plate 28 to move needle 32 permits fuel gauge 10 to minimize hydrocarbon emissions to atmosphere as a result of leaking gauges.

A fuel gauge 10 is adapted to extend into a fuel tank 12 to reach and sense a level of liquid fuel 42 extant in fuel tank 12 as suggested in FIG. 2. Illustratively, fuel gauge 10, in accordance with the present disclosure, includes a fuel cap 14, a fuel-level indicator 18, and an indicator positioner 22 as shown in FIGS. 1 and 2. Fuel cap 14 is configured to mate with a fuel-tank filler neck 16 and retain fuel gauge 10 on fuel tank 12 during use. Fuel-level indicator 18 is used to visually communicate the level of liquid fuel 42 sensed by indicator positioner 22.

As shown in FIG. 2, fuel cap 14 includes a housing 26, also called handle 26, a seal plate 28, and a seal 29. Fuel cap 14 is adapted to mate with a fuel-tank filler neck 16 included in fuel tank 12. Seal plate 28 includes an inner surface 24 arranged to face toward fuel tank 12 and an opposite outer surface 20 arranged to face away from fuel tank 12. Seal 29 is arranged to lie between housing 26 and fuel-tank filler neck 16 as suggested in FIG. 2.

Fuel-level indicator 18, as shown in FIG. 3, includes fuel-level display 30, a needle 32, and a display lens 34. Fuel-level display 30 is coupled to outer surface 20 of seal plate 28 and arranged to face away from fuel tank 12. Needle 32 is coupled to fuel-level display to pivot about a pivot axis 13 that is aligned with fuel-tank filler neck 16. Needle 32 is configured to move in response to a magnetic field. Display lens 34 is coupled to fuel-level display 30 to define a sealed display space 104 between display lens 34 and fuel-level display 30.

As shown in FIG. 3, indicator positioner 22 includes a level float 38, a base receiver 48, and a float-rotation guide 46, also called a base-support rod 46. Indicator positioner 22 further includes needle-mover means 112 for moving needle 32 contained in sealed display space 104 to a position on fuel-level display 30 associated with the fuel tank level measured by level float 38 floating in liquid fuel 42 to communicate visually the fuel tank level so that fuel vapor 106 in fuel tank 12 is retained in fuel tank 12 and blocked from communicating with atmosphere outside fuel tank 12 when fuel cap 14 is coupled to fuel-tank filler neck 16.

The base receiver 48, as shown in FIG. 1, is positioned to lie in spaced-apart relation to seal plate 28 in fuel tank 14. Float-rotation guide 46 is coupled to seal plate 28 on one end 52 and to base receiver 48 on an opposite end 54. Float-rotation guide 46 is arranged to extend in a downward direction 108 away from seal plate 28 toward a bottom 110 of fuel tank 12 to interconnect base receiver 48 and seal plate 28 as suggested in FIG. 3. Level float 38 is coupled to float-rotation guide 46 and is configured for up-and-down movement relative to float-rotation guide 46.

As suggested in FIG. 2, needle mover means includes a twistable-guide rod 58 and a magnetic arm 60 configured to provide magnetic means for moving needle 32 about pivot axis 13 in response to up-and-down movement of level float 38 floating on liquid fuel 42 in fuel tank 12. Illustratively, magnetic arm 60 is coupled to inner surface 24 of seal plate 28 to rotate about an axis of rotation. As shown in FIG. 1, axis of rotation and pivot axis 13 are arranged to lie in coextensive relation to one another. Alternatively, axis of rotation may be arranged to lie in spaced-apart parallel relation to pivot axis 13. Twistable-guide rod 58 is coupled to level float 38 to convert up-and-down movement of level float 38 into rotational movement of twistable-guide rod 58 and magnetic arm 60 as suggested in FIG. 2.

Magnetic arm 60 includes a pivot support 78, a magnet receiver 80, and a magnet 82 as shown in FIG. 3. Pivot support 78 is coupled to inner surface 24 of seal plate 28 to rotate freely about the axis of rotation relative to seal plate 28. Magnet receiver 80 is coupled to pivot support 78 and is arranged to extend away from pivot support 78 toward housing 26. Magnet 82 is coupled to magnet receiver 80 to move therewith and is configured to provide the magnetic field to move needle 32.

As shown in FIG. 3, level float 38 illustratively includes a float body 72 formed to include a support-rod slot 76 opening through float body 72 and a guide-rod channel 74 opening through float body 72. Support-rod slot 76 is configured to allow float-rotation guide 40 to extend therethrough. Guide-rod channel 74 is configured to allow twistable-guide rod 58 to extend therethrough. Guide-rod channel 74 and support-rod slot 76 cooperate to restrain up-and-down movement of float body 72 relative to seal plate 28.

Illustratively, fuel gauge 10 includes an engine-supply connection 92 as shown in FIG. 1. Engine-supply connection 92 is coupled to seal plate 28 and arranged to open into a fuel-conducting passageway 94 formed in float-rotation guide 46 to move liquid fuel 42 in fuel tank 12 through fuel-conducting passageway 94. As an example, engine-supply connection 92 is open to fuel-conducting passageway 94 when a quick-connect fuel-supply line (not shown) is coupled to engine-supply connection 92. When the quick-connect fuel-supply line is not coupled to engine-supply connection 92, seal plate 28 operates as substantially non-perforate plate to block fuel vapor 106 from exiting fuel tank 12. As an example, fuel gauge 10 may be formed without engine-supply connection 92. Furthermore, base-support rod 46 may be substantially solid, but may be sealed on one end so that no fuel may communicate through it.

As shown in FIG. 3, needle 32 includes a needle-pivot nub 102 and an elongated needle body 96. Needle-pivot hub is appended to outer surface 20 of seal plate 28 and arranged to extend away from seal plate 28 opposite downward direction 108. Elongated needle body 96 is coupled to needle-pivot nub 102 and arranged to extend toward housing 26. Needle 32, when in the full-tank position is arranged to lie at about zero degrees relative to pivot axis 13 in a horizontal plate. Needle 32 when moving from full-tank position to the empty-tank position pivots through a span of about 180 degrees in a counter-clockwise direction to assume empty-tank position.

As suggested in FIG. 2, needle-mover means 112 includes magnetic arm 60 and twistable-guide rod 58. Magnetic arm 60 is coupled to inner surface 24 of seal plate 28 and is arranged in spaced-apart relation to needle 32 relative to seal plate 28. Twistable-guide rod 58 is coupled to level float 38 to covert up-and-down movement of level float 38 into rotational movement of guide rod 58 and magnetic arm 60. As an example, magnet 82 is arranged to align with needle 32 to provide the magnetic field to move needle 32 during changes in the liquid fuel level in fuel tank 12.

Fuel gauge 10, in another illustrative embodiment, includes means for establishing a magnetic coupling between a magnetic arm 60 located in an interior region of fuel cap 14 with a volume-indication needle 32 mounted for rotation about a pivot axis 13 on an exterior surface of fuel cap 14 without establishing any hole in fuel cap 14 to communicate the rotation of a twistable-guide rod 58 about an axis of rotation as a result of a level float 38 moving along the twistable-guide rod 58 sensing the liquid fuel level within the fuel tank to cause the volume-indication needle to move to a position associated with the liquid-fuel level sensed by the level float 38 to retain fuel vapor 106 in fuel tank 12 when fuel cap 14 is coupled to fuel-tank filler neck 16.

Furthermore, substantially sealed fuel-level indicator 18 minimizes the buildup of fuel vapor 106 in a sealed display space 104 defined by fuel-level display 30 and display lens 34. Sealed fuel-level indicator 18 minimizes condensation of water vapor from atmosphere and condensation of fuel vapor 106 in sealed fuel-level indicator 18. By minimizing the collection of fuel vapor in sealed fuel-level indicator 18, discoloration of display lens 34 is also minimized thereby improving the ability of a user to use fuel gauge 10.

As shown diagrammatically in FIG. 2, a fuel system 100 includes a fuel tank 12, a fuel-tank cap 114, and a fuel-tank gauge 110. As an example, fuel tank 12 is formed to include an aperture 116 opening into an interior region 118 formed in fuel tank 12. Fuel-tank cap 114 is removably mounted to fuel tank 12 to close aperture 116 opening into interior region 118 of fuel tank 12.

Fuel-tank gauge 110 includes a needle 32 and a buoyant float 38. Needle 32 is mounted on an exterior portion 120 of fuel-tank cap 114 to pivot about a pivot axis 13. Buoyant float 38 is positioned to lie in interior region 118 of fuel tank 12 to move up and down with the rise and fall of liquid fuel 42 in fuel tank 12.

Fuel-tank gauge 110 further includes needle-mover means 112 located wholly in interior region 118 of fuel tank 12 for pivoting needle 32 about pivot axis 13 in response to up-and-down movement of buoyant float 38 floating on liquid fuel 42 so that needle 32 moves to a position on fuel-tank cap 114 associated with an amount of liquid fuel 42 sensed by buoyant float 38 in fuel tank 12. Needle-mover means 112 includes a magnetic arm 60 and a twistable-guide rod 58 that is coupled to the magnetic arm to move therewith. As suggested in FIG. 2, needle-mover means 112 is positioned to lie between needle 32 and buoyant float 38 to provide means for magnetically moving needle 32 without extending through an aperture formed in fuel-tank cap 114.

1. A fuel gauge adapted to extend into a fuel tank to reach and sense a level of liquid fuel extant in the fuel tank, the fuel gauge comprising
a fuel cap including a housing adapted to mate with a fuel-tank filler neck included in the fuel tank, a seal plate having an inner surface arranged to face toward the fuel tank and an opposite outer surface arranged to face away from the fuel tank, the seal plate being coupled to the housing to move therewith, and an O-ring seal arranged to lie between the seal plate and the fuel-tank filler neck to establish a seal therebetween,
a fuel-level indicator including a fuel-level display coupled to an outer surface of the seal plate, a needle coupled to the fuel-level display to move about a pivot axis aligned with the fuel-tank filler neck between an empty-tank position and a full-tank position, and a display lens coupled to the fuel-level display to define a sealed display space between the display lens and the fuel-level display, and
an indicator positioner including a buoyant float arranged to lie within the fuel tank and configured to float on a surface of the liquid fuel in the fuel tank to sense a level of the liquid fuel extant in the fuel tank and needle-mover means for moving the needle contained in the sealed display space to a position on the fuel-level display associated with the level of liquid fuel sensed by the buoyant float floating in the liquid fuel and to communicate visually the level of liquid fuel extant in the fuel tank so that fuel vapor in the fuel tank is retained in the fuel tank and blocked from communicating with atmosphere outside the fuel tank when the fuel cap is coupled to the fuel-tank filler neck.

2. The fuel gauge of claim 1, wherein the indicator positioner further includes a base receiver positioned to lie in spaced-apart relation to the seal plate in the fuel tank and a float-rotation guide coupled to the seal plate on one end and to the base receiver on an opposite end, the float-rotation guide is arranged to extend in a downward direction away from the seal plate toward a bottom of the fuel tank to interconnect the base receiver and the seal plate, and the buoyant float is coupled to the float-rotation guide and is arranged to move up and down relative to the float-rotation guide.

3. The fuel gauge of claim 2, wherein the needle-mover means includes a guide rod and a magnetic arm, the magnetic arm is configured to provide magnetic means for providing a magnetic field to move the needle about the pivot axis in response to up-and-down movement of the buoyant float, the magnetic arm is coupled to the inner surface of the seal plate to rotate about an axis of rotation relative to the seal plate, and the guide rod is coupled to the magnetic arm to move therewith and to the buoyant float to convert up-and-down movement of the buoyant float into movement of the guide rod and magnetic arm about the axis of rotation.

4. The fuel gauge of claim 3, wherein the magnetic arm includes a pivot support coupled to the inner surface of the seal plate and arranged to rotate about the axis of rotation relative to the seal plate, a magnet receiver appended to the pivot support and arranged to extend in a radial direction away from the pivot support, and a magnet coupled to the magnet receiver to move therewith and configured to provide the magnetic field.

5. The fuel gauge of claim 4, wherein the buoyant float is formed to include a first support-rod aperture opening into a support-rod passageway formed in the float body and a second support-rod aperture opening into the support-rod passageway and the float-rotation guide is arranged to extend into the first support-rod slot, to lie in the support-rod passageway, and to extend out of the second support rod slot.

6. The fuel gauge of claim 2, further comprising an engine-supply line receiver configured to provide means for receiving an engine-supply line coupled to the seal plate to interconnect the engine fuel-supply line to a fuel-conducting passageway formed in the float-rotation guide to move the liquid fuel extant in the fuel tank through the fuel-conducting passageway into the engine fuel-supply line to be transported to the engine when the fuel cap is coupled to the fuel-tank filler neck so that fuel vapor is retained in the fuel tank and blocked from communicating with atmosphere outside the tank while the liquid fuel in the tank is withdrawn from the fuel tank.

7. The fuel gauge of claim 1, wherein the needle includes a needle-pivot hub appended to the outer surface of the seal plate and arranged to extend away from the seal plate and an elongated needle body is coupled to the needle-pivot hub and arranged to move about the pivot axis relative to the seal plate and extend radially outward from the needle-pivot hub toward the housing.

8. The fuel gauge of claim 7, wherein the needle when in the full-tank position moves about the pivot axis through a span of about 180 degrees in a counter-clockwise direction to assume the empty-tank position.

9. The fuel gauge of claim 1, wherein the needle-mover means includes a guide rod and a magnetic arm, the magnetic arm is coupled to the inner surface of the seal plate and is arranged to lie in spaced-apart relation to the needle to rotate about an axis of rotation relative to the seal plate, the guide rod is coupled to the magnetic arm to move therewith and is coupled to the buoyant-float to convert up-and-down movement of the buoyant float into rotational movement of the guide rod and the magnetic arm.

10. The fuel gauge of claim 9, wherein the magnetic arm includes a pivot support coupled to the inner surface of the seal plate and arranged to rotate about the axis of rotation, a magnet receiver appended to the pivot support and arranged to extend in a radial direction away from the pivot support toward the housing, and a magnet coupled to the magnet receiver to move therewith and arranged to align with the needle to provide a magnetic field to move the needle during changes in the level of liquid fuel extant in the fuel tank.

11. A fuel system comprising:
a fuel tank formed to include an aperture opening into an interior region formed in the fuel tank,
a closure-mounted to the fuel tank to close the aperture opening into the interior region of the fuel tank, and
a fuel gauge including a needle mounted on an exterior portion of the closure to move about a pivot axis relative to the closure, a buoyant float positioned to lie in the interior region of the fuel tank to move up and down with rise and fall of the liquid fuel in the fuel tank, and needle-mover means located wholly in the interior region of the fuel tank for moving the needle about the pivot axis in response to up-and-down movement of the buoyant float floating on the liquid fuel in the fuel tank so that the needle moves to a position on the closure associated with an amount of liquid fuel sensed by the buoyant float in the interior region of the fuel tank.

12. The fuel system of claim 11, wherein the needle-mover means includes a magnetic arm and a twistable-guide rod coupled to the magnetic arm and arranged to move therewith and the needle-mover means is positioned to lie between the needle and the buoyant float to provide means for magnetically moving the needle without extending through an aperture formed in the closure.

13. The fuel system of claim 12, wherein the closure includes a housing adapted to mate with the fuel tank to retain the closure on the fuel tank, a seal plate coupled to the housing to move therewith, the seal plate includes an inner surface arranged to face toward the aperture and an opposite outer surface arranged to face away from the aperture, and an O-ring seal arranged to lie between the seal plate and the fuel tank to establish a seal between the closure and the fuel tank, and wherein the opposite outer surface of the seal plate and the housing cooperate to establish the outer portion of the closure.

14. The fuel gauge of claim 13, wherein the magnetic arm includes a pivot support coupled to the inner surface of the seal plate and arranged to rotate about an axis of rotation relative to the seal plate, a magnet receiver appended to the pivot support and arranged to extend in a radial direction away from the pivot support toward the housing, and a magnet coupled to the magnet receiver to rotate therewith about the axis of rotation.

15. The fuel gauge of claim 14, wherein the axis of rotation is positioned to align in coextensive relation to the pivot axis.

16. The fuel gauge of claim 14, wherein the axis of rotation is positioned to lie in spaced-apart parallel relation to the pivot axis.

17. The fuel system of claim 12, wherein the fuel gauge further includes a base receiver positioned to lie in spaced-apart relation to the fuel-tank cap in the interior region of the fuel tank to locate the buoyant float between the base receiver and the closure and a float-rotation guide coupled to the closure on one end and to the base receiver on an opposite end and the buoyant float is coupled to the float-rotation guide and arranged to move up and down relative to the float-rotation guide.

18. The fuel system of claim 17, wherein the twistable-guide rod includes a top pivot tab coupled to the magnetic arm to rotate freely about an axis of rotation relative to the closure, a bottom pivot tab coupled to the base receiver to rotate freely about the axis of rotation relative to the base receiver, and a central portion arranged to interconnect the top pivot tab and the bottom pivot tab, and wherein the bottom pivot tab is oriented 180 degrees about the axis of rotation relative to top pivot tab to cause the central portion to have a helical shape.

19. The fuel system of claim 11, wherein the fuel-tank gauge further includes a fuel-level display coupled to the outer portion of the closure and positioned to lie between the needle and the closure and a display lens coupled to the fuel-level display to define a sealed display space therebetween, and wherein the needle is positioned to lie within the sealed display space.

20. A fuel gauge adapted to extend into a fuel tank to reach and sense a level of liquid fuel extant in the fuel tank, the fuel gauge comprising
a fuel cap including a housing adapted to mate with a fuel-tank filler neck included in the fuel tank, a seal plate having an inner surface arranged to face toward the fuel tank and an opposite outer surface arranged to face away from the fuel tank, the seal plate being coupled to the housing to move therewith, and a seal arranged to lie between the seal plate and the fuel-tank filler neck to establish a sealed union therebetween,
a fuel-level indicator including a fuel-level display coupled to an outer surface of the seal plate, a needle coupled to the fuel-level display and arranged to move about a pivot axis aligned with the fuel-tank filler neck relative to the fuel-level display between an empty-tank position and a full-tank position, and a display lens coupled to the fuel-level display to define a sealed display space therebetween, and
an indicator positioner including a buoyant float arranged to lie within the fuel tank and configured to float on a surface of the liquid fuel in the fuel tank to sense a level of liquid fuel extant in the fuel tank and a needle mover coupled to the buoyant float to covert up-and-down movement of the buoyant float into movement of the needle about the pivot axis, wherein the needle mover includes a magnetic arm coupled to the seal plate to rotate about an axis of rotation relative to the seal plate and a twistable-guide rod coupled to the magnetic arm to move therewith, the magnetic arm is arranged to lie in spaced-apart relation to the needle to locate the seal plate therebetween and is configured to provide a magnetic field to couple the needle to the magnetic arm through the seal plate to move the needle about the pivot axis.
